(19) United States
(12) Patent Application Publication
(10) Pub. No.: US 2023/0125897 A1
(43) Pub. Date: Apr. 27, 2023

(54) CATEGORICAL FEATURE SELECTION FOR RANKING MODELS

(71) Applicant: META PLATFORMS, INC., Menlo Park, CA (US)

(72) Inventors: Aditya Srinivas Timmaraju, Sunnyvale, CA (US); Pushkar Tripathi, Sunnyvale, CA (US)

(21) Appl. No.: 18/048,793

(22) Filed: Oct. 21, 2022

Related U.S. Application Data
(60) Provisional application No. 63/270,759, filed on Oct. 22, 2021.

(51) Int. Cl. G06Q 30/02; G06F 16/9536

(52) U.S. Cl. CPC G06Q 30/0255; G06F 16/9536

(57) ABSTRACT

Machine Learning based ranking models are ubiquitous in powering recommendation engines at internet companies. These models typically use a combination of real-valued numerical and categorical features to generate predictions. Feature selection may be a widely encountered problem in this setting, that entails picking the optimal set of features as inputs to these models from a large pool of candidate real-valued and categorical features. A novel feature selection algorithm for categorical features building on stochastic neural networks is provided. It is shown empirically through results, the superiority of this algorithm over existing approaches. Study and proposal of best practices are also provided to practitioners to extract maximum value out of the new feature selection approach.

### CROSS REFERENCE TO RELATED APPLICATIONS

This application claims priority to U.S. Provisional Application No. 63/270,759 filed Oct. 22, 2021, the entire contents of which is incorporated in its entirety herein by reference.

### TECHNOLOGICAL FIELD

Exemplary embodiments of this disclosure relate generally to methods, apparatuses and computer program products for utilizing stochastic neurons for categorical feature selection in neural networks, and in particular, to stochastic neurons that enable selection of a random subset of categorical features for a ranking model in neural networks.

### BACKGROUND

Machine Learning based models are at the heart of the engines that power ranking and recommendation services at internet companies. These include ranking videos, posts, images, advertisements (ads) and other kinds of content. For some social networks, the most used ranking models may power several trillion predictions each day. These models help sort among the many pieces of content eligible to be shown to a user, optimizing for various metrics. In applications such as ranking ads, machine learning may play a central role in computing the expected utility of showing a candidate ad to a user.

### BRIEF SUMMARY

In search advertising, the input user query is used to first filter candidate ads from a larger set, which are matched to the query either through implicit or explicit means. For some social networks, ads may not be associated with a query, but instead specify demographic and interest targeting. As a result, the volume of eligible ads to be chosen from when a user visits the social network, may be larger than that for search advertising. To deal with this large candidate set, exemplary embodiments may employ multi-stage ranking with each stage filtering down ads and growing in model complexity. As described herein, exemplary embodiments may perform experiments on the last stage click prediction model, that is the model that produces predictions for the final set of candidate ads.

These models typically rely on several hundreds of real-valued and categorical features, which are in turn to be picked from a pool of several thousands of features. The number of features that may be used in a model may be constrained by serving memory and compute constraints. For a simple ranking model architecture such as Deep Factorization-Machine (FM), the computational cost of the input layer may scale quadratically in the number of features participating in interactions. The above drawbacks may necessitate the use, by the exemplary embodiments, of a feature selection algorithm for picking the optimal set of features to be used in a given ranking model.

Ranking models rely on broadly two kinds of features which may differ principally in their input representations namely real-valued (e.g., numerical or dense) and categorical (e.g., sparse) features. Real-valued features may be those which are represented using scalar real values viz., average click-through rate on a given ad. Categorical features may be those which are represented as a one-hot vector of the length of the number of categories. Examples of categorical features may include language of a post, semantic category of an ad, etc. Categorical features may typically be densified by employing an embedding layer before being passed as inputs to the rest of the model. These embedding layers may house a parameter variable of size and number of categories x embedding dimension. Such embedding layers may allow for rich semantic and contextual information to be learned and stored in each of the embedding vectors corresponding to various indices of the categorical feature.

Feature selection methods may be divided into three categories: Filter methods, Wrapper methods, and Intrinsic/Embedded methods. Filter methods typically may not involve a learning component and may work like a pre-processing step. These methods may use a statistical measure of each individual feature to sort features by importance. These measures may include feature variance, correlation to the output variable among other metrics. They typically may fail to account for dependencies across features. On the other hand, Wrapper methods may involve the use a learned classifier to determine the importance of each feature. Wrapper methods may typically work by using a subset of features each time (with one or more features added or removed sequentially) and using the resulting classifier performance as a proxy for feature importance. Because they involve training a classifier for each such feature subset, they can be computationally expensive especially for large feature pools and complex classifiers such as those used for recommendation engines. The third variety, Intrinsic/Embedded methods may be designed to pick the important subset of features during model training itself and may thereby avoid the overhead of Wrapper methods. Examples of these may include usage of decision trees, Least Absolute Shrinkage and Selection Operator (LASSO). While it may seem attractive to extend LASSO to neural networks, gradient descent with an L1 penalty added to the loss in practice may not sparsify the input layer as desired.

The exemplary embodiments may adapt the sparsification method using stochastic gates to the categorical feature selection problem.

Additionally, the exemplary embodiments may demonstrate empirically, the superiority of this method over existing feature selection approaches.

Further, extensive experiments were conducted by exemplary embodiments to enable provision of useful advice for practitioners to best leverage this method in large-scale recommendation models.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

FIG. 1 is a diagram of an exemplary network environment associated with a social-networking system in accordance with an embodiment.

FIG. 2 is a diagram of an exemplary computer system in accordance with an embodiment.

FIG. 3 is a diagram of a Deep Learning Recommendation Model (DLRM) in accordance with an embodiment.

FIG. 4 is a diagram of Multiplicative Gating Neurons in a DLRM in accordance with an embodiment.

FIG. 5 is a diagram of another Multiplicative Gating Neurons in a DLRM in accordance with another embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

It is to be understood that the methods and systems described herein are not limited to specific methods, specific components, or to particular implementations. It is also to be understood that the terminology used herein is for the purpose of describing particular embodiments only and is not intended to be limiting.

### Exemplary System Architecture

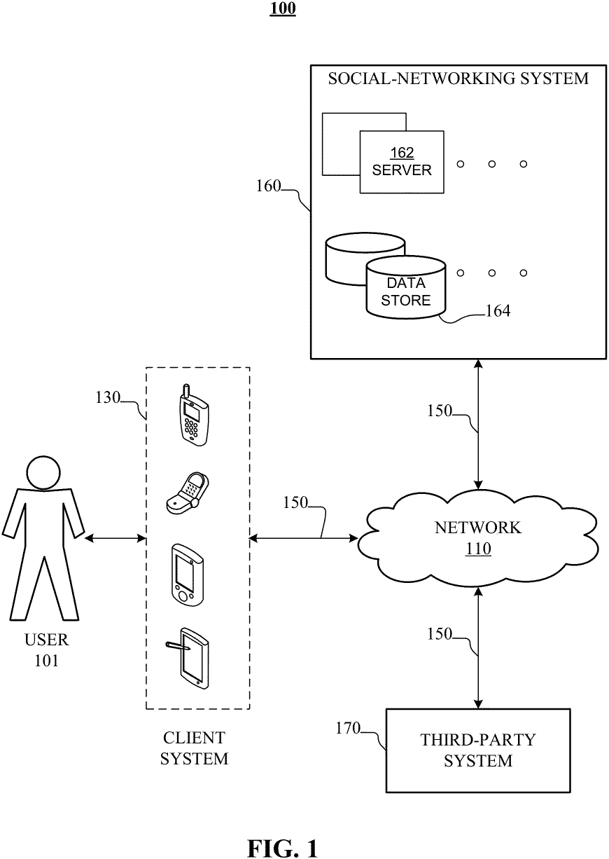

FIG. 1 illustrates an example network environment 100 associated with a social-networking system 160. Network environment 100 includes a user 101, a client system 130, a social-networking system 160, and a third-party system 170 connected to each other by a network 110. Although FIG. 1 illustrates a particular arrangement of user 101, client system 130, social-networking system 160, third-party system 170, and network 110, this disclosure contemplates any suitable arrangement of user 101, client system 130, social-networking system 160, third-party system 170, and network 110. As an example and not by way of limitation, two or more of client system 130, social-networking system 160, and third-party system 170 may be connected to each other directly, bypassing network 110. As another example, two or more of client system 130, social-networking system 160, and third-party system 170 may be physically or logically co-located with each other in whole or in part. Moreover, although FIG. 1 illustrates a particular number of users 101, client systems 130, social-networking systems 160, third-party systems 170, and networks 110, this disclosure contemplates any suitable number of users 101, client systems 130, social-networking systems 160, third-party systems 170, and networks 110. As an example and not by way of limitation, network environment 100 may include multiple client systems 130, social-networking systems 160, third-party systems 170, and networks 110.

In particular embodiments, user 101 may be an individual (human user), an entity (e.g., an enterprise, business, or third-party application), or a group (e.g., of individuals or entities) that interacts or communicates with or over social-networking system 160. In particular embodiments, one or more users 101 may use one or more client systems 130 to access, send data to, and receive data from social-networking system 160 or third-party system 170.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, social-networking system 160, and third-party system 170 to communication network 110 or to each other. This disclosure contemplates any suitable links 150. In particular embodiments, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, client system 130 may be an electronic device including hardware, software, or embedded logic components or a combination of two or more such components and capable of carrying out the appropriate functionalities implemented or supported by client system 130. As an example, and not by way of limitation, a client system 130 may include a computer system such as a desktop computer, notebook or laptop computer, netbook, a tablet computer, e-book reader, Global Positioning System (GPS) device, camera, personal digital assistant (PDA), handheld electronic device, cellular telephone, smartphone, augmented/virtual reality device, other suitable electronic device, or any suitable combination thereof. This disclosure contemplates any suitable client systems 130. A client system 130 may enable user 101 to access network 110. A client system 130 may enable its user 101 to communicate with other users 101 at other client systems 130.

In particular embodiments, social-networking system 160 may be a network-addressable computing system that may host an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. As an example and not by way of limitation, client system 130 may access social-networking system 160 using a web browser or a native application associated with social-networking system 160 (e.g., a mobile social-networking application, a messaging application, another suitable application, or any combination thereof) either directly or via network 110. In particular embodiments, social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, social-networking system 160 may store one or more social graphs in one or more data stores 164. In particular embodiments, a social graph may include multiple nodes—which may include multiple user nodes (each corresponding to a particular user 101) or multiple concept nodes (each corresponding to a particular concept)— and multiple edges connecting the nodes. Social-networking system 160 may provide users 101 of the online social network the ability to communicate and interact with other users 101. In particular embodiments, users 101 may join the online social network via social-networking system 160 and then add connections (e.g., relationships) to a number of other users 101 of social-networking system 160 to whom they want to be connected. Herein, the term “friend” may refer to any other user 101 of social-networking system 160 with whom a user 101 has formed a connection, association, or relationship via social-networking system 160.

In particular embodiments, social-networking system 160 may provide users 101 with the ability to take actions on various types of items or objects, supported by social-networking system 160. As an example and not by way of limitation, the items and objects may include groups or social networks to which users of social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 160 or by an external system of third-party system 170, which may be separate from social-networking system 160 and coupled to social-networking system 160 via a network 110.

In particular embodiments, social-networking system 160 may be capable of linking a variety of entities. As an example and not by way of limitation, social-networking system 160 may enable users to interact with each other as well as receive content from third-party systems 170 or other entities, or to allow users to interact with these entities through an application programming interfaces (APIs) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating social-networking system 160. In particular embodiments, however, social-networking system 160 and third-party systems 170 may operate in conjunction with each other to provide social-networking services to users of social-networking system 160 or third-party systems 170. In this sense, social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 160 may also include user-generated content objects, which may enhance a user’s interactions with social-networking system 160. Content may also be added to social-networking system 160 by a third-party through a “communication channel,” such as a newsfeed or stream.

In particular embodiments, social-networking system 160 may include a variety of servers, sub-systems, programs, modules, logs, and data stores. In particular embodiments, social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 160 may also include suitable components such as network interfaces, security mechanisms, load balancers, failover servers, management-and-network-operations consoles, other suitable components, or any suitable combination thereof. In particular embodiments, social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 160 to one or more client systems 130 or one or more third-party systems 170 via network 110. The web server may include a mail server or other messaging functionality for receiving and routing messages between social-networking system 160 and one or more client systems 130. An API-request server may allow a third-party system 170 to access information from social-networking system 160 by calling one or more APIs. An action logger may be used to receive communications from a web server about a user’s actions on or off social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from client system 130 responsive to a request received from client system 130. Authorization servers may be used to enforce one or more privacy settings of the users of social-networking system 160. A privacy setting of a user may determine how particular information associated with a user can be shared. The authorization server may allow users to opt in to or opt out of having their actions logged by social-networking system 160 or shared with other systems (e.g., third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

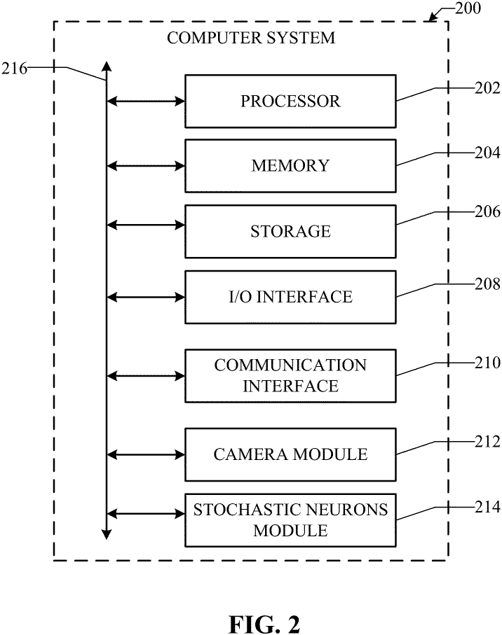

FIG. 2 illustrates an example computer system 200. In particular embodiments, one or more computer systems 200 may perform one or more steps of one or more methods described or illustrated herein. In some example embodiments, the computer system 200 may be the server 162 of social-networking system 160. In other example embodiments, the computer system 200 may be the client system 130. In particular embodiments, one or more computer systems 200 may provide functionality described or illustrated herein. In particular embodiments, software running on one or more computer systems 200 may perform one or more steps of one or more methods described or illustrated herein or provides functionality described or illustrated herein. Particular exemplary embodiments may include one or more portions of one or more computer systems 200. Herein, reference to a computer system may encompass a computing device, and vice versa, where appropriate. Moreover, reference to a computer system may encompass one or more computer systems, where appropriate.

This disclosure contemplates any suitable number of computer systems 200. This disclosure contemplates computer system 200 taking any suitable physical form. As example and not by way of limitation, computer system 200 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 200 may include one or more computer systems 200; be unitary or distributed; span multiple locations; span multiple machines; span multiple data centers; or reside in a cloud, which may include one or more cloud components in one or more networks. Where appropriate, one or more computer systems 200 may perform without substantial spatial or temporal limitation one or more steps of one or more methods described or illustrated herein. As an example and not by way of limitation, one or more computer systems 200 may perform in real time or in batch mode one or more steps of one or more methods described or illustrated herein. One or more computer systems 200 may perform at different times or at different locations one or more steps of one or more methods described or illustrated herein, where appropriate.

In particular embodiments, computer system 200 may include a processor 202, memory 204, storage 206, an input/output (I/O) interface 208, a communication interface 210, camera module 212, stochastic neurons module 214, and a bus 216. Although this disclosure describes and illustrates a particular computer system having a particular number of particular components in a particular arrangement, this disclosure contemplates any suitable computer system having any suitable number of any suitable components in any suitable arrangement.

In particular embodiments, processor 202 may include hardware for executing instructions, such as those making up a computer program. As an example and not by way of limitation, to execute instructions, processor 202 may retrieve (or fetch) the instructions from an internal register, an internal cache, memory 204, or storage 206; decode and execute them; and then write one or more results to an internal register, an internal cache, memory 204, or storage 206. In particular embodiments, processor 202 may include one or more internal caches for data, instructions, or addresses. This disclosure contemplates processor 202 including any suitable number of any suitable internal caches, where appropriate. As an example and not by way of limitation, processor 202 may include one or more instruction caches, one or more data caches, and one or more translation lookaside buffers (TLBs). Instructions in the instruction caches may be copies of instructions in memory 204 or storage 206, and the instruction caches may speed up retrieval of those instructions by processor 202. Data in the data caches may be copies of data in memory 204 or storage 206 for instructions executing at processor 202 to operate on; the results of previous instructions executed at processor 202 for access by subsequent instructions executing at processor 202 or for writing to memory 204 or storage 206; or other suitable data. The data caches may speed up read or write operations by processor 202. The TLBs may speed up virtual-address translation for processor 202. In particular embodiments, processor 202 may include one or more internal registers for data, instructions, or addresses. This disclosure contemplates processor 202 including any suitable number of any suitable internal registers, where appropriate. Where appropriate, processor 202 may include one or more arithmetic logic units (ALUs); be a multi-core processor; or include one or more processors 202. Although this disclosure describes and illustrates a particular processor, this disclosure contemplates any suitable processor. In some example embodiments, the stochastic neurons module 214 may utilize stochastic neurons to select an optimal set of features (e.g., an optimal feature subset from a full set of features) for one or more ranking models, as described more fully below.

In particular embodiments, memory 204 may include main memory for storing instructions for processor 202 to execute or data for processor 202 to operate on. As an example and not by way of limitation, computer system 200 may load instructions from storage 206 or another source (such as, for example, another computer system 200) to memory 204. Processor 202 may then load the instructions from memory 204 to an internal register or internal cache. To execute the instructions, processor 202 may retrieve the instructions from the internal register or internal cache and decode them. During or after execution of the instructions, processor 202 may write one or more results (which may be intermediate or final results) to the internal register or internal cache. Processor 202 may then write one or more of those results to memory 204. In particular embodiments, processor 202 executes only instructions in one or more internal registers or internal caches or in memory 204 (as opposed to storage 206 or elsewhere) and operates only on data in one or more internal registers or internal caches or in memory 204 (as opposed to storage 206 or elsewhere). One or more memory buses (which may each include an address bus and a data bus) may couple processor 202 to memory 204. Bus 216 may include one or more memory buses, as described below. In particular embodiments, one or more memory management units (MMUs) reside between processor 202 and memory 204 and facilitate accesses to memory 204 requested by processor 202. In particular embodiments, memory 204 may include random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 204 may include one or more memories 204, where appropriate. Although this disclosure describes and illustrates particular memory, this disclosure contemplates any suitable memory.

In particular embodiments, storage 206 includes mass storage for data or instructions. As an example and not by way of limitation, storage 206 may include a hard disk drive (HDD), a floppy disk drive, flash memory, an optical disc, a magneto-optical disc, magnetic tape, or a Universal Serial Bus (USB) drive or a combination of two or more of these. Storage 206 may include removable or non-removable (or fixed) media, where appropriate. Storage 206 may be internal or external to computer system 200, where appropriate. In particular embodiments, storage 206 may be non-volatile, solid-state memory. In particular embodiments, storage 206 may include read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 206 taking any suitable physical form. Storage 206 may include one or more storage control units facilitating communication between processor 202 and storage 206, where appropriate. Where appropriate, storage 206 may include one or more storages 206. Although this disclosure describes and illustrates particular storage, this disclosure contemplates any suitable storage.

In particular embodiments, I/O interface 208 includes hardware, software, or both, providing one or more interfaces for communication between computer system 200 and one or more I/O devices. Computer system 200 may include one or more of these I/O devices, where appropriate. One or more of these I/O devices may enable communication between a person and computer system 200. As an example and not by way of limitation, an I/O device may include a keyboard, keypad, microphone, monitor, mouse, printer, scanner, speaker, camera module 212 (e.g., a still camera, a video camera), stylus, pointing device, tablet, touch screen, trackball, another suitable I/O device or a combination of two or more of these. An I/O device may include one or more sensors. This disclosure contemplates any suitable I/O devices and any suitable I/O interfaces 208 for them. Where appropriate, I/O interface 208 may include one or more device or software drivers enabling processor 202 to drive one or more of these I/O devices. I/O interface 208 may include one or more I/O interfaces 208, where appropriate. Although this disclosure describes and illustrates a particular I/O interface, this disclosure contemplates any suitable I/O interface.

In particular embodiments, communication interface 210 may include hardware, software, or both providing one or more interfaces for communication (such as, for example, packet-based communication) between computer system 200 and one or more other computer systems 200 or one or more networks. As an example and not by way of limitation, communication interface 210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 210 for it. As an example and not by way of limitation, computer system 200 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 200 may include any suitable communication interface 210 for any of these networks, where appropriate. Communication interface 210 may include one or more communication interfaces 210, where appropriate. Although this disclosure describes and illustrates a particular communication interface, this disclosure contemplates any suitable communication interface.

In particular embodiments, bus 216 includes hardware, software, or both coupling components of computer system 200 to each other. As an example and not by way of limitation, bus 216 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 216 may include one or more buses 216, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Exemplary System Operation

The base ranking model architecture utilized by the exemplary embodiments for exposition of the method is described herein. The background and problem setup are then described. Thereafter, a description is provided of the proposed extension to apply the proposed extension to categorical feature selection.

### A. Deep Learning Based Recommendation Model (DLRM)

With the advent of deep learning, neural network based models have proliferated into ranking, recommendation and personalization applications in the industry. When practitioners first began to design neural network architectures for these applications, they typically had to contend with the different kinds of features presented to these models vis-a-vis those architectures that had been devised and popularized in early deep learning literature. While numerical (e.g., dense) inputs may be trivial to process through a Multi-Layer Perceptron (MLP) like architecture, it may not be directly evident how best to process categorical inputs which describe high level attributes. While one part of this question may be the input representation for categorical features, it may also be unclear how best to make them interact deeper inside the architecture.

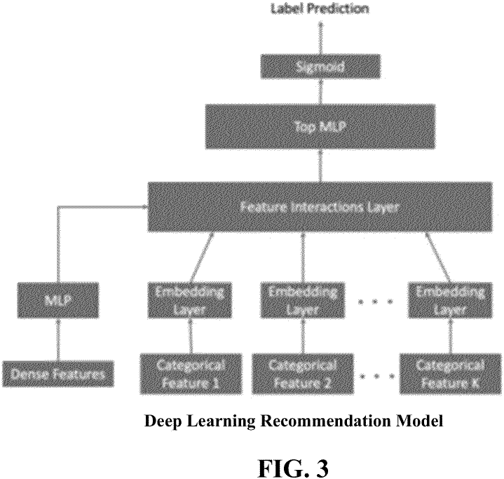

Some social networks may utilize a simple architecture to solve these problems called the Deep Learning for Recommendation Model (DLRM). In this architecture as shown in FIG. 3, for the input representation, categorical features may be processed using an embedding layer, while continuous features may be processed using an MLP. Thereafter, second-order interactions may be computed among all pairs of features explicitly. On top of these computed interactions, there is another top MLP which may feed into a sigmoid function to output the probability of the desired event (for example, an ad click).

### B. Stochastic Neurons for Feature Selection

Feature selection may be posed as a subset selection problem from the universe of all available features. This problem may be Non-deterministic Polynomial (NP)-hard in the general case owing to the combinatorially large search space, thus forcing choosing between either sub-optimal feature selection methods that make impractical independence assumptions or inefficient computation.

Over the last decade, examples of machine learning aiding the solution of such theoretically hard problems have been identified. This raises the intriguing possibility of whether it may be possible to learn the importances of features, just as parameters are learned in a model end-to-end using gradient descent. Of course, unlike traditional parameter learning, this may be complicated by the discrete nature of the subset selection operation. Typically, such roadblocks have been tackled in literature using algorithms such as REINFORCE (i.e., a known algorithm). But this approach may suffer from high variance and may be computationally expensive given the large model sizes used in production ranking systems.

To motivate the use of stochastic neurons, simpler options are first considered at hand. For example, the exemplary embodiments may gate input features through an element-wise multiplicative layer of binary neurons, and may then incentivize the model to only keep a fraction of these neurons alive. The L0 norm of the vector of gating values may serve to capture this quantitatively. However, minimizing the L0 norm may be unwieldy to gradient-based optimization owing to non-differentiability of the L0 norm. This may motivate turning to stochastically sampling the gating values from distributions, for whose choices the expected L0 norm of the gating vector is differentiable. The simple case of binary gates, which may be sampled from Bernoulli distributions are considered. This time around, the expected L0 norm may be easy to compute, as a sum of the Bernoulli parameters. However, the click-label cross entropy loss now may have dependence on the binary gates and thus it may be hard to minimize without resorting to Straight-through estimator or REINFORCE-like techniques.

To get around this, the stochastic neurons module 214 may attempt to smooth the discrete gates while also crucially allowing for exact zeros. This may be done using a simple hard-sigmoid rectifier e.g., min(1, max(0, x)) applied to samples from a continuous distribution. The stochastic neurons module 214 may now choose distributions under which the expected L0 norm is differentiable. While the stochastic neurons module 214 may have flexibility in this choice, it may choose either the Binary Concrete distribution or the Gaussian distribution. The stochastic neurons module 214 may learn the parameters of these distributions at each of the feature gating neurons. While some existing techniques may be interested in learning sparse neural networks, the stochastic neurons module 214 may, in some exemplary embodiments, apply a layer of stochastic neurons only at the input layer for the purpose of selecting features. Crucially, in some existing techniques, only gates that eventually attain a value 0 may be useful for the end goal of sparsity. However, in the case of feature selection, the stochastic neurons module 214 may interpret the resultant gate distribution parameter values as the importance of various features, and may use these to retain any desired number of features for training the ranking model. The stochastic neurons module 214 may rank features in this way as meaningful because of the nature of gradient-based learning e.g., features whose gates may need to be eventually pushed to zero may first need to be lowered through that continuum. The stochastic neurons module 214 may verify this hypothesis empirically.

While the above expositions detail the application of multiplicative gating for dense features, it may be unclear how best to extend this for categorical features which are represented as a one-hot vector in the input layer. Two possible ways to extend this algorithm to categorical features are now described, while also keeping in mind how they are used in the DLRM model.

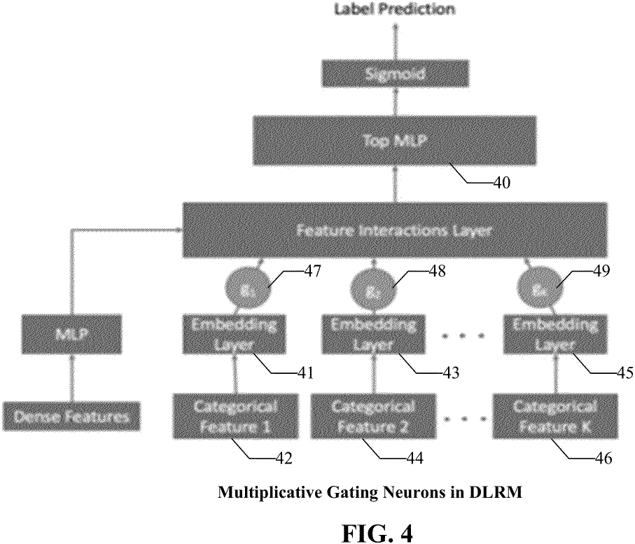

1) Individual Feature Gating: In this method, the stochastic neurons module 214 may create one stochastic neuron per categorical feature, and may gate its entire embedding (after embedding layer lookup) to pass through this neuron. The stochastic neurons module 214 may use such a gate sharing mechanism because a feature may either be present or absent in its entirety, but not partially present. FIG. 4 illustrates how this is applied in the DLRM model.

The Individual Feature Gating approach of the exemplary embodiments may improve optimization of the feature selection inputs to a Multi-Layer Perceptron architecture associated with a ranking model (e.g., an ads ranking model). For example, there may be 2,000 features determined as being associated with a ranking model. As an example only, these 2,000 features may be associated with all possible interests expressed by users in a social network.

However, as an example, only the top 400 features may be provided as inputs to the ranking model. In this regard, the Individual Feature Gating approach may be implemented by the stochastic neurons module 214 to determine which of the 2,000 features are the top 400 features for the ranking model.

In this manner, for example, the stochastic neurons module 214 may determine different categorical features 42, 44, 46 associated with a ranking model (as shown in FIG. 4). The categorical features 42, 44, 46, etc. may be represented by corresponding embedding layers 41, 43, 45, etc. (as shown in FIG. 4). For purposes of illustration and not of limitation, a categorical feature 42 may relate to which webpages users of a social network may have liked to visit over a time period (e.g., within the last week) which may be associated with the embedding layer 41. Another categorial feature 44 may be associated with the types of plasma televisions (TVs) that users of the social network liked over a time period (e.g., within the last week) based on visiting TV webpages, which may be associated with another embedding layer 43. The TV webpage visits may be determined by analyzing the users browsing history. Other categorical features (e.g., preferred rideshare services, road transportation, etc.) may be associated with corresponding embedding layers in a similar manner.

The categorial features associated with the embedding layers may be input to stochastic gates 47, 48, 49 (as shown in FIG. 4). The stochastic neurons module 214 may implement the stochastic gates 47, 48, 49 such that the stochastic gates 47, 48, 49 may determine whether the corresponding categorical feature (e.g., categorial feature 42) is provided to the ranking model (or not provided to the ranking model) associated with the MLP 40 (as shown in FIG. 4). In this regard, for example, the stochastic neurons module 214 may determine importance scores for each of the categorical features (e.g., 2,000 features) and may pass the top categorical features (e.g., top 400 features) from the set of features (e.g., the 2,000 features) having non-zero importance scores for example within a score range, as referred to herein as gating values, (e.g., between 0 and 1) to a ranking model associated with the MLP 40. The scoring that may be attributed to a feature(s) may be a deterministic function of the learned parameter value (e.g., through neural network training) of its gate distribution.

2) Gating on Pairwise Interactions: In the DLRM model, the primary mode of consumption of categorical features by the neural network (NN) may be through pairwise interactions of features. These pairwise interactions may allow to evolve semantic meaning to the input features. For example, in the application to ads click prediction, these interactions may capture the synchrony between a certain user characteristic (e.g., stated user interests) and an ad characteristic (e.g., ad category). So, taking this view of the model, it may be reasonable to attribute importances to individual features based on importances of interactions that a feature participates in.

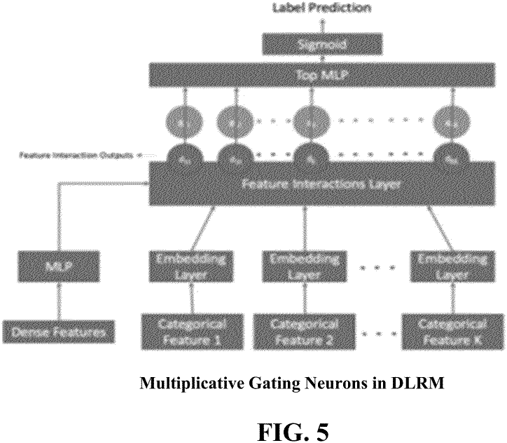

In this extension, it is proposed to apply multiplicative gating on top of the interactions layer output. The stochastic neurons module 214 may then map learned gating values at the pairs level to individual features by suitable averaging. This design is illustrated in FIG. 5. The Gating on Pairwise Interactions approach, implemented by the stochastic neurons module 214, may be the same or similar approach to the stochastic neurons module 214 implementation of the Individual Feature Gating approach described above. The Gating on Pairwise Interactions approach may be another manner of answering/addressing the same question/issue as the Individual Feature Gating approach. In the Gating on Pairwise Interactions approach, the stochastic neurons module 214 may first compute importances for pairs of features. The stochastic neurons module 214 may then compute the importance of an individual feature as the average importance of all feature pairs that the individual feature is part of.

Below is a review of some of the work both on feature selection generally and on ranking models specifically.

### A. Filter Methods

Filter methods as known may not involve a learning component and may work like a pre-processing step. These methods may use a statistical measure of each individual feature to sort features by importance. These measures may include feature variance, correlation to the output variable among other metrics. The filter methods may typically fail to account for dependencies across features.

### B. Wrapper Methods

Wrapper methods as known may involve the use a learned classifier to determine the importance of each feature. Wrapper methods may typically work by using a subset of features each time (with one or more features added or removed sequentially) and may use the resulting classifier performance as a proxy for feature importance. Because Wrapper methods may involve training a classifier for each such feature subset, they can be computationally expensive especially for large feature pools and complex classifiers such as those used for recommendation engines.

### C. Embedded Methods

Embedded methods may be designed to pick the important subset of features during model training itself and may thereby avoid the overhead of Wrapper methods. Examples of these may include usage of decision trees, and Least Absolute Shrinkage and Selection Operator (LASSO). While it may seem attractive to extend LASSO to neural networks, gradient descent with an L1 penalty added to the loss in practice may not sparsify the input layer as desired.

Previously, some researchers have accounted for this by developing ways to use the L0 penalty which may serve better to capture the presence/absence of a feature without penalizing absolute value. In some existing techniques, the notion of using stochastic neurons for inducing sparsity is introduced. In an existing technique, for example, a Binary Concrete distribution may be used to model the gating values. The reparametrization trick may be used to allow for gradient based learning of the distributional parameters. In some other existing approaches, an unsupervised feature selection method using a Concrete layer at the input may be utilized. In other traditional approaches, an input reconstruction loss may be used for driving the parameter training, with an optional supervised extension. In some other traditional approaches, stochastic gates may be applied to real-valued feature selection utilized on numerical features Additionally, some existing approaches tout using Gaussian as the underlying distribution choice as working better than Binary Concrete for feature selection settings. There is also some existing techniques involving re-purposing the Integrated Gradients feature attribution work for the application of feature selection.

However, unlike prior approaches, the exemplary embodiments may be directed to the usage of stochastic gates for categorical feature selection in ranking models. The exemplary embodiments also consider systematic study of design choices that practitioners confront when applying techniques to large scale models.

### Experiments

In this section, results from experiments are described regarding the proposed feature selection method. In all experiments, the DLRM architecture may be utilized for the models. An event prediction model may be utilized (for example by stochastic neurons module 214) and its corresponding datasets across all experiments to maintain consistency across findings. In this example, the size of the categorical feature pool is 2,000. After a feature selection run is performed on this entire pool, the stochastic neurons module 214 may rank features by their computed importance values and pick the top features (e.g., the top 400 features) for use in the ranking model. The stochastic neurons module 214 may use the DLRM architecture for the feature selection model runs, except when stated otherwise. The stochastic neurons module 214 may also utilize an optimization algorithm and may track the normalized cross entropy (NCE) of the event prediction task as the primary metric of comparison. For each experiment, the stochastic neurons module 214 may report relative improvements or drops in NCE compared to the baseline. As described herein, the proposed method may be referred to as Categorical Stochastic Neurons (CSN) in the comparisons.

### A. Comparing Different Algorithms

The proposed method for categorical feature selection may be compared against multiple strong baselines including the shuffle-based method, the Integrated Gradients method as well as the choice between using stochastic neurons on pairwise interactions versus at an individual feature level. As shown in the data below, it can be seen that the stochastic neurons method outperforms existing approaches significantly (e.g., lower NCE is better). As shown in the data below, it can also be seen that gating at an individual feature level may work better than gating on pairwise interactions and thereafter mapping gating values to individual feature importances.

TABLE I

COMPARING DIFFERENT ALGORITHMS

| Method | Relative NCE | FS Run time |
|---|---|---|
| IG | - | |
| Random | 0.17% | |
| CSN Individual | -0.04% | |
| CSN Pairwise Importance Average | -0.02% | |
| CSN Feature Occurrence in Top Pairs | 0.1% | |

TABLE II

COMPARING DISTRIBUTIONS

| Method | Relative NCE |
|---|---|
| CSN Binary Concrete | - |
| CSN Gaussian | 0.003% |

TABLE III

EFFECT OF DATA VOLUME IN FS RUN

| Method | Relative NCE | FS Run time (hours) |
|---|---|---|
| CSN 1B | - | 46 |
| CSN 3B | -0.015% | 60.5 |
| CSN 5B | -0.018% | 102.7 |
| CSN 7B | -0.019% | 137 |

### B. Comparing Choices of Distribution

Two different choices of the underlying distribution governing gating neurons are now described. The first candidate is the Binary Concrete distribution, which is parametrized using the log(a) parameter and beta (which is set to 0.5). The second candidate is the Gaussian distribution, which is parametrized using the mean, with the variance found using hyperparameter tuning. As can be determined from Table II, both perform very similarly across settings. For example, Table II shows that the relative difference between the Binary Concrete distribution and the Gaussian distribution is only 0.003%, which is insignificant.

### C. Studying the Effect of Data Volume

A natural question that a practitioner may pose is “What is the right data volume to use for the Feature Selection (FS) run?” It seems intuitive that using more data may help with learning the importance of features better, but is there a saturation point beyond which it may not help with improving downstream ranking model loss minimization? This question was studied by varying the data volume used for the FS run. It was determined (for example, by the stochastic neurons module 214) that in the low data regime, there is an improvement in downstream model performance with more data added, but that this advantage may saturate as the volume increases.

### D. Studying Critical Hyperparameters

One of the most important requirements from the output of the Feature Selection run may be the importance of features thus computed (e.g., by the stochastic neurons module 214) provide a total ordering among the input feature pool. With the stochastic neurons approach, the gating values are constrained to be in [0, 1]. For this reason, if several (e.g., greater than a constant K) features are either saturated at an importance of 1.0 or squashed down to 0, then it may not be possible to find the top K features from the feature pool. This provided motivation to study which hyperparameters may have the most significant bearing on the number of importances that settle to the open interval (0, 1). It was hypothesized that the learning rate of the FS run may be a critical hyperparameter. Through experiments, it was determined (for example by the stochastic neurons module 214) that the learning rate may give practitioners a powerful way to control for the dynamic range of feature importance. This was measured using a proxy - i.e., the number of features whose importances settle in (0, 1). This metric was measured as a function of the a parameter in an optimization algorithm and the findings are indicated in Table IV.

TABLE IV

EFFECT OF LEARNING RATE

| Method | Relative NCE | # Importances in (0,1) |
|---|---|---|
| CSN, α = le⁻² | - | 1259 |
| CSN, α = 7e⁻³ | 0.011% | 1752 |
| CSN, α = 3e⁻³ | 0.033% | 2000 |
| CSN, α = le⁻³ | 0.026% | 2000 |

### Conclusion

In this disclosure, the motivation behind devising effective feature selection algorithms for ranking and recommendation models is described. Recent developments involving stochastic neural networks are discussed, along with relevant extensions to the feature selection problem. This idea is then extended to work for categorical feature selection. Advice to practitioners to best utilize this method for their models is also described herein.

As extensions to the stochastic neural network developments provided by the exemplary embodiments, study regarding the effect of performing feature selection of both numerical features and categorical features (and possibly other kinds of features) together in a single FS run may be performed. While the exemplary embodiments may use hyperparameter search for setting optimal values for L0 regularization strength, it may be studied whether there are more systematic ways of estimating optimal values for these parameters. These extensions may also be the subject of future work.

What is claimed:

1. A method comprising:
analyzing a set of categorical features associated with a plurality of users of a social network;
providing respective categorical features associated with corresponding embedding layers to corresponding stochastic gates;
determining scores associated with each of the categorical features provided to the stochastic gates; and
determining a subset of the categorical features to provide to a ranking model based on determined top scores associated with each of the categorical features.

2. The method of claim 1, wherein the categorical features having determined scores that are not within the top scores are prevented from being provided to the ranking model.

3. The method of claim 1, wherein the top scores are determined as being within a range of score values.

4. The method of claim 1, wherein the social network is associated with a stochastic neuron network.
